(19) United States
(12) Patent Application Publication
(10) Pub. No.: US 2011/0161132 A1
(43) Pub. Date: Jun. 30, 2011

(54) METHOD AND SYSTEM FOR EXTRACTING PROCESS SEQUENCES

(76) Inventors: Sukriti Goel, Bangalore (IN); Jyoti M. Bhat, Bangalore (IN); Anmol Ratan Bhuinya, Shahdol (IN)

(21) Appl. No.: 12/717,174

(22) Filed: Mar. 4, 2010

(30) Foreign Application Priority Data
Dec. 29, 2009 (IN) 3191/CHE/2009

(51) Int. Cl. G06Q 10/00

(52) U.S. Cl. 705/7.26; 705/348

(57) ABSTRACT

A system and method for extracting process sequences from application data is provided. The method includes extracting process sequences from one or more applications' historical data in a non-intrusive manner. Firstly, data events in application data sources are read and then mapped to business activities. While reading the data events, a correlation identifier is identified which is later used to correlate business activities to create the process instance sequences. The system and method may be used to extract process sequences of multiple processes simultaneously. Process sequences may further be used for the purpose of mining processes from legacy systems for compliance checking solutions and for identifying how individual process instances are executed.

### FIELD OF INVENTION

The present invention relates generally to the field of data processing. More particularly, the present invention provides for extracting process sequences from application data.

### BACKGROUND OF THE INVENTION

With increase in complexity of today's business environment, a typical business may comprise multiple business applications executing in parallel for implementing business functions. For example, an industrial business environment may include business applications related to product manufacturing, purchase order processing, sales process, administrative process, processes related to human resources etc. Each business application comprises a list of activities associated with executing the application.

Business process extraction includes using existing system data available as a result of executed business applications for deriving independent business processes. Currently used business technologies, such as, Business Process Management System (BPMS) and workflows have explicit business process models. However, there are business applications where business processes are not explicitly mentioned. Prior art methods for business process extraction include deriving business processes and creating process models. Methods currently used for deriving business processes include studying of code manually or using software tools, adding probes to system, processing transaction data or events and implementing process mining algorithms. However, these methods suffer from a number of disadvantages. Studying of code manually or using software tools is a cumbersome process, whereas the method of adding probes to system involves observing the system for a considerable period of time to ensure a representative sample of all possible process sequences. Another problem might be that delays may need to be introduced into process execution to be able to get data to mine the process being executed. A necessary requirement with use of process mining algorithms is that process mining algorithms require data in a specific structured format as input, in order to process the data and output a process model.

Based on the above limitations, there is a need for an automated system and method for extracting process sequences from application data without the requirement of having the application data to exist in a specified structured format.

### SUMMARY OF THE INVENTION

A method and system for extracting process sequences from application data is provided. In various embodiments of the present invention, application data related to numerous business applications being executed is stored in system datastore including but not limited to databases, flat files and log files The method includes identifying and extracting data events from the application data. The method further includes mapping events to business activities. Thereafter, the business activities are correlated to create process instance sequences. Finally, in one embodiment, the extracted sequence data is converted into format required by process mining algorithms. In another embodiment, the process sequence data is used for compliance checking In yet another embodiment, the process sequence data is used to determine how the process sequence was executed. In various embodiments of the present invention, the one or more software applications are independent of a particular software platform. The method additionally includes inputting formatted data into a process mining algorithm for generating a process model.

In various embodiments of the present invention, the process related events extracted are actions on process data such as update operations and write operations. The process related events may be identified from target points within application data which are mapped to end or start of an activity of a business process. The target points may be at least one of database tables, logs and audit tables.

In various embodiments of the present invention, the link between activities belonging to a common process instance is identified by matching the unique identifier for each activity. Consequent to the checking of unique identifier, the activities are ordered based on their time stamp to create process instance sequences. The unique identifier may be a correlation identifier used for correlating one or more business activities belonging to a common process instance. Correlating activities comprises passing the correlation identifier through activities belonging to a common process instance in order to create process instance sequences.

The method of the invention includes creating event definitions for associating an event to a business activity using the mapping rules. Thereafter, each event is mapped to a business activity.

In various embodiments of the present invention, the system of the present invention includes an event creation module configured to create business transactions from datastore events logged by various business transactions in applications. Further, the system includes an event handler configured to associate one or more events to a relevant activity. Moreover, the system includes a configuration module configured to provide an interface to a user to define mapping between one or more data events and one or more business activities and a process sequence generator configured to create process sequences for each process instance.

### BRIEF DESCRIPTION OF THE ACCOMPANYING DRAWINGS

The present invention is described by way of embodiments illustrated in the accompanying drawings wherein:

FIG. 1 illustrates a typical order processing and dispatch process in a business environment;

FIG. 2 is a flowchart illustrating method steps for extracting process sequences, in accordance with an embodiment of the present invention;

FIGS. 3, 4 and 5 demonstrate a mechanism for extracting process sequences, in accordance with an embodiment of the present invention;

FIG. 6 illustrates block diagram of a process sequence mining tool, in accordance with various embodiments of the present invention;

FIG. 7 illustrates sample format of a query file used for querying databases; and

FIG. 8 illustrates sample format of a rule template table.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been briefly described or omitted so as not to unnecessarily obscure the present invention.

The present invention would now be discussed in context of embodiments as illustrated in the accompanying drawings.

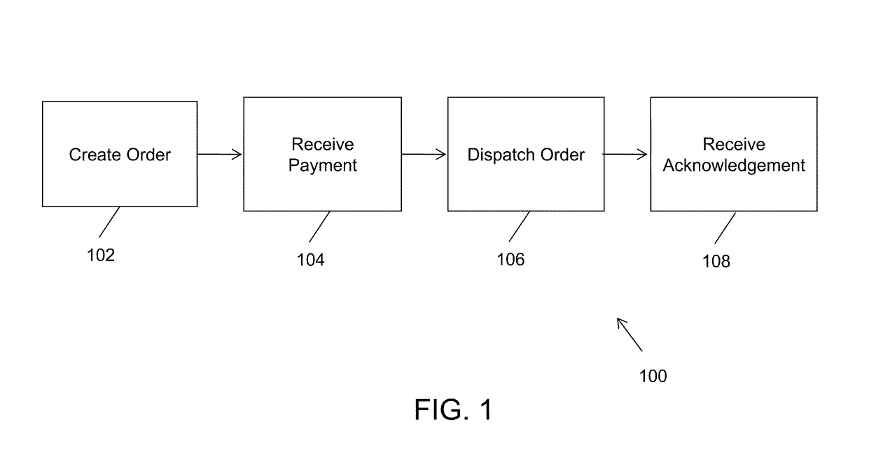

FIG. 1 illustrates a typical order processing and dispatch process 100 in a business environment. A usual business process comprises a set of activities associated with the process. Each activity is termed a business activity. As shown in the figure, the activities associated with the order processing and dispatch process 100 are: Create Order 102, Receive Payment 104, Dispatch Order 106 and Receive Acknowledgement 108. Each business activity may be part of more than one business process. For example, Create Order 102 may be part of a business process (order processing and dispatch process 100) and another business process (Supply Chain Management). Further, a business activity may include one or more events. Events are incidents that make up a business activity. For example, inserting a record in “OrderDetails” table is an event associated with the business activity Create Order 102. Events can be database events or file events. In an example, inserting a record in “OrderDetails” table is a database event, whereas file events are creation of files, writing to a file etc. Each instance of an event provides valuable information about an activity of a business process, for example, a database event where record is inserted in “OrderDetails” table would mean that a new order has been created. The events captured provide information like execution time, associated data like agents and artifacts related with the event, and any other information that gives character to specific occurrence of that type of event. For example the events captured for the order processing and dispatch process 100 may be generation of order id, payment id, dispatch id and updating receipt status. The occurrence of these events may be recorded by performing a database insert or update operation in associated tables.

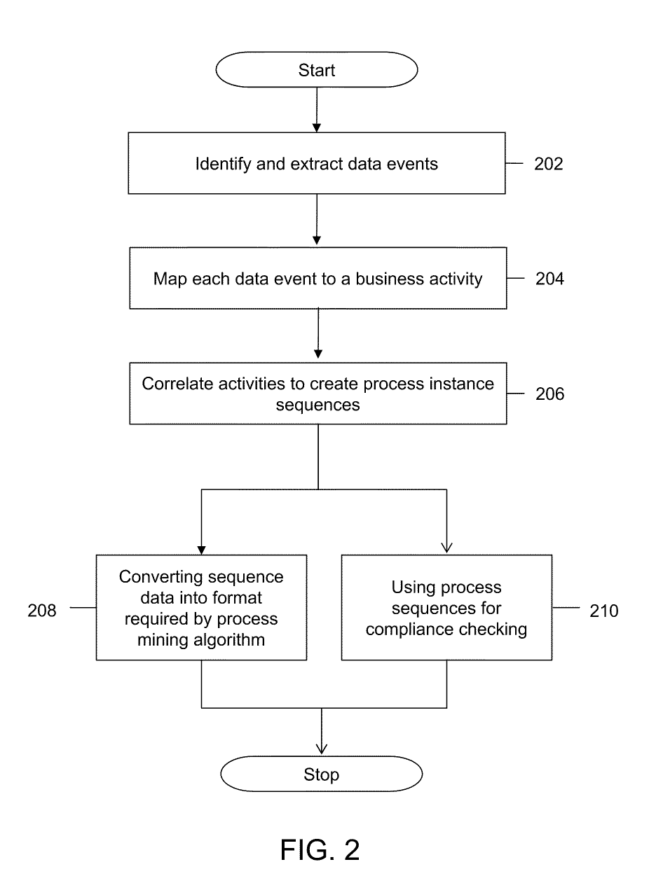

FIG. 2 is a flowchart illustrating method steps for extracting process sequences, in accordance with an embodiment of the present invention. At step 202, data events are identified and extracted. The information associated with data events that is extracted includes type of event, correlation identifier and timestamp information. In an embodiment of the present invention, multiple events are processed and only important or meaningful events are mapped to business activities. Important events are events that are central or necessary to a business activity. For example, inserting an order activity in “OrderDetails” table is an essential event associated with the business activity ‘Create Order’. Unimportant events are ignored and are not associated with any activity.

At step 204, each data event is mapped to a business activity. In an embodiment of the present invention, a cloud of business activities is created corresponding to events. For example, an ‘Insert’ event in the “PurchaseRequisition” table may be mapped to a business activity: “Create Purchase Request”.

At step 206, a sequence of events related to a process is determined. In an embodiment of the present invention, the sequence of events is determined by creating a unique identifier for each process instance. The unique identifier is a correlation identifier used for correlating events corresponding to different business activities but belonging to a common process instance. Each correlation identifier created is assigned to activities belonging to a common process. By assigning correlation identifiers to activities, process instance sequences are created.

Finally, at step 208, sequence data is converted into format that may be required by a process mining algorithm. A process mining algorithm may then use the process sequences available in a structured format to extract relevant data. Alternatively, at step 210, the process sequences extracted are utilized for compliance checking In an embodiment of the present invention, the process sequences extracted are used to determine how process sequences are executed.

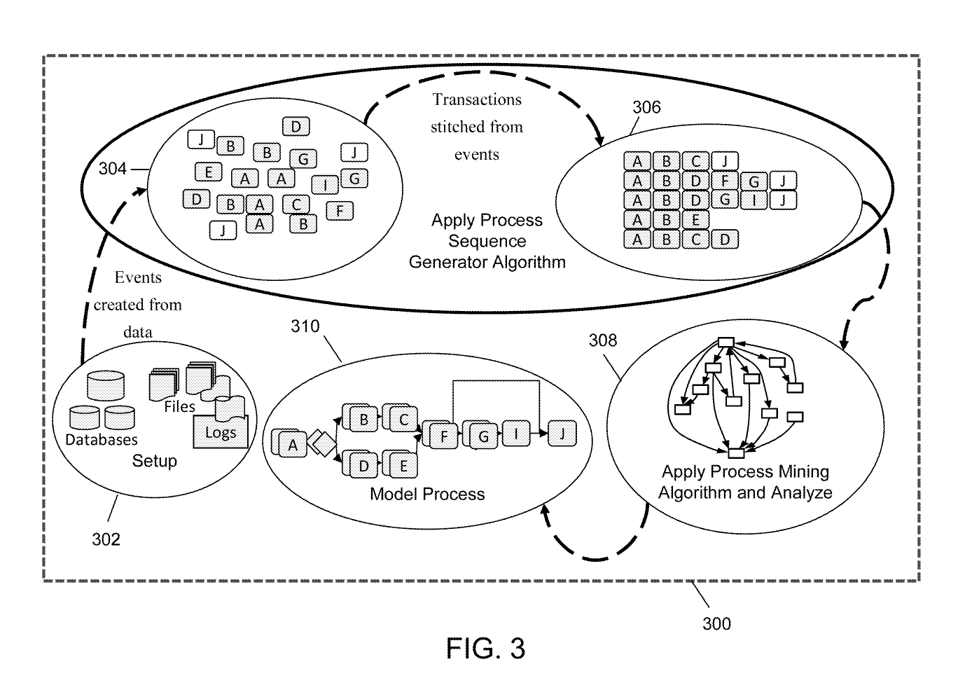

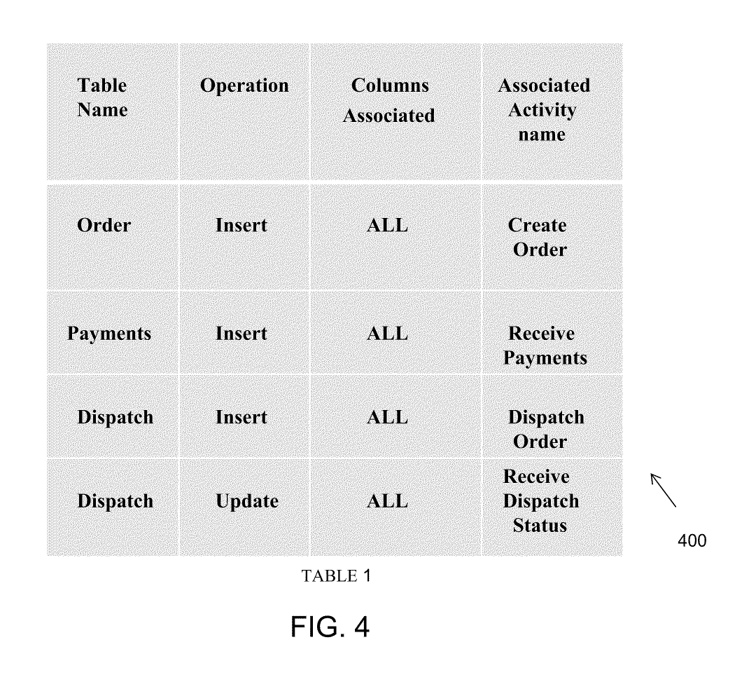

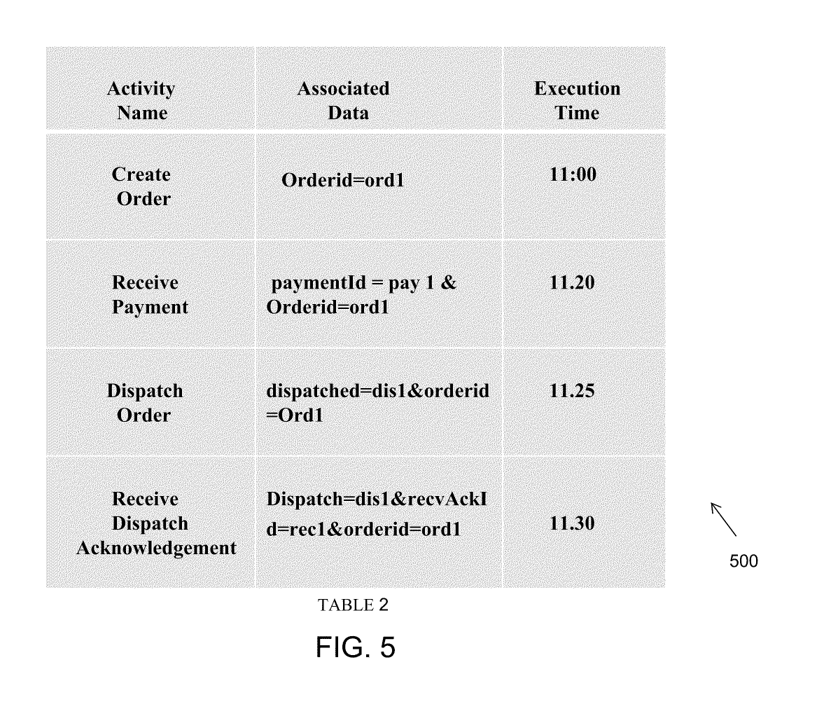

FIGS. 3, 4 and 5 demonstrate a mechanism for extracting process sequences, in accordance with an embodiment of the present invention. FIG. 3 illustrates stages in the course of extracting process sequences whereas FIGS. 4 and 5 illustrate information generated in tabular format for facilitating process sequence extraction. As shown in FIG. 3, the stages in the extraction of sequences are: Setup 302, Capturing events 304, Creating process sequence 306, Process Mining 308 and Creating Process Models 310. In an embodiment of the present invention, process extraction mechanism processes multiple events from an event cloud and generates process models from the events. The Setup stage 302 is configured to extract data related to business activities generated by a business application during its execution. The data may be persistent data stored in databases, log files, flat files etc. In an exemplary embodiment, the data may be stored in database tables, such as, master table, audit table, transaction tables etc. The Setup stage 302 includes analyzing relevant tables and identifying events. In most system applications, update of data columns of transaction tables occurs with logging of timestamps. The logged timestamps may then be used for identifying events. In an example, an ‘Insert’ operation may be identified as an event, where date and time of raising purchase request is captured by system application in a purchase requisition table associated with application data. In another example, update of columns associated with a purchase request record, such as, date/timestamp column is also identified as an event. In yet another example, audit trails may be used to identify events, since audit trails captures timestamps of all important events associated with an application. After data extraction, the stage Capturing Events 304 extracts relevant events from the extracted data. The events generated by a business application may be system events, application events or transaction events like order creation etc. Relevant events are events such as actions on process data like updates and writes related to a business activity. In an exemplary embodiment of the present invention, events are identified from target points within data. Some of the target points may map to an end or start of an activity of a business process. Based on these target points, significant events are identified and an event definition can be created. Event definitions are used to map events (or collection of events) to a business activity as illustrated in Table 1 (Sample template of event definitions) in FIG. 4. As per Table 1 in FIG. 4, Insert operation in the ‘Payments’ table is associated with the business activity ‘Receive Payments’.

Relevant events extracted from the stage Capturing events 304 are connected together using a correlation identifier to create process instance sequences at the Creating activity cloud stage 306. In an embodiment of the present invention, application data becomes available in an application for every activity and is specific to that instance of the process. A unique correlation identifier from the application data is identified for events connected to a single process instance. Examples of the unique correlation identifier may be activity data, non-activity related data, generated data (e.g. serial number created in the database). In an exemplary embodiment of the present invention, an activity execution would insert a new row in an Order table. This would insert values for order identifier and other columns. This key value pair Orderid=ord1 is one example of an unique identifier that gives character to the specific occurrence of the data event (Insert operation on Order Table) and the associated Business activity (Create Order).

In an embodiment of the present invention, each data event is mapped to a business activity and thereafter an activity cloud is generated. For correlating activities, the unique identifier is matched across all activities. As shown in Table 2 of FIG. 5, which illustrates sample transaction data, the associated data for the activity CreateOrder generates an order identifier: ord1. Corresponding to the activity CreateOrder, the identifier ord1 for the process instance say, P00001, may be used for correlating activities. Ordl is populated across relevant activities captured in the sample transaction data. Thus, at the occurrence of the activity: Receive Payment the associated data contains the identifier ord1 in addition to the payment identifier pay1. By assigning identifier ord1 to the activity, the linkage of activity: Receive Payment to process instance P00001 is established. Similarly, for the activity, Dispatch Order, the identifier orderid is assigned in addition to the dispatch identifier dis1. Thus, it may be verified from associated data in previous activities that execution of the activity: DispatchOrder belongs to process instance P00001.

After the creation of process sequences in the Creating Process Sequence stage 306, process mining algorithms are executed in the stage: Process Mining 308. In an embodiment of the present invention, a heuristic algorithm may be used for the process mining. Based on the mined process, a process sequence is modeled using a standard process modeler at the stage: Process Models 310.

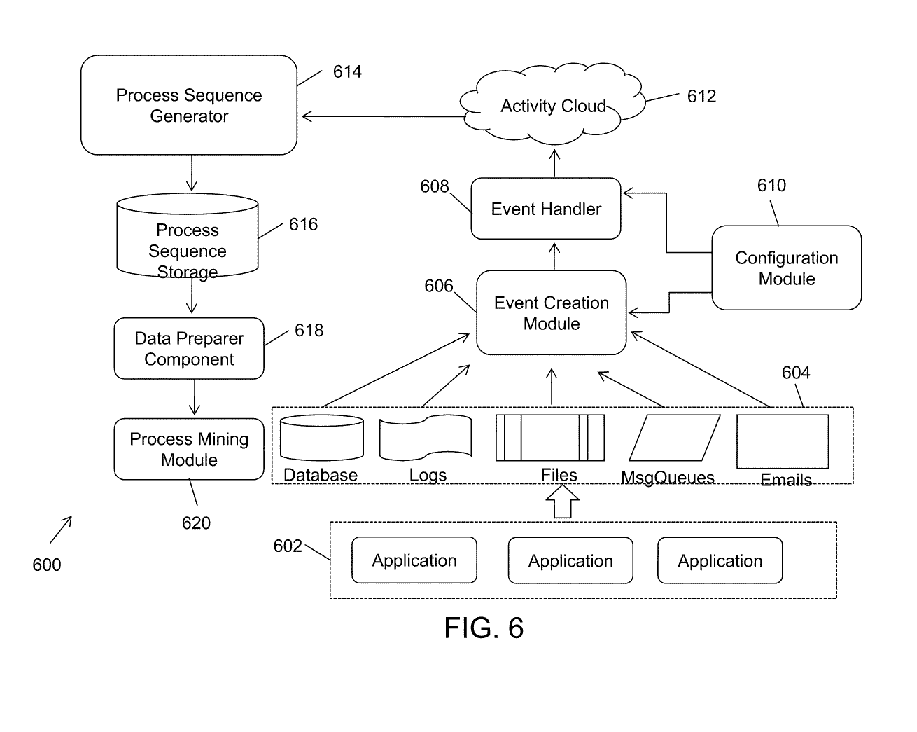

FIG. 6 illustrates block diagram of a process sequence mining tool 600, in accordance with various embodiments of the present invention. The process mining tool 600 comprises the following modules: an application module 602, data sources 604, an event creation module 606, an event handler 608, a configuration module 610, an activity cloud 612, a process sequence generator 614, a process sequence storage 616, a data preparer component 618 and a process mining module 620. As shown in the figure, the application module 602 includes one or more software applications. Software applications persist data in storage systems such as databases, file systems etc. Since most applications are unaware of processing of other applications, data logged in by business activities of various applications is not in sync with each other. The repository 604 illustrates various elements where data is stored by various software applications. The elements include databases, logs, files, message queues, emails etc.

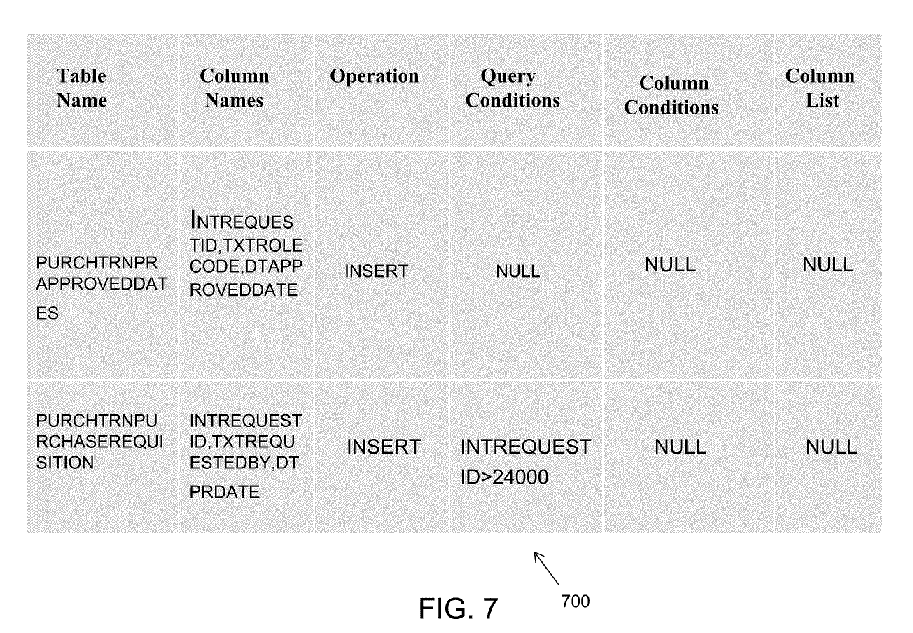

The process mining tool 600 includes the event creation module 606 that creates data events from database changes logged by various business transactions. In an embodiment of the present invention, an initial step for creating data events includes querying databases containing data stored by one or more software applications. The event creation module 606 takes inputs from the configuration module 610 for creating the data events. The configuration module 610 provides an interface to a user to input data and conditions for creating events. Based on inputs received from the user, query information is created. The sample query information for a database contains transaction table name, columns identified, and other necessary conditions and data required for querying database tables and creating business events. In an example, the query information provides flexibility to the user by providing an opportunity to modify a query on the fly and execute the tool again to capture events. A sample format of query information is illustrated in FIG. 7. In an embodiment, information in the query information is converted into Structured Query Language (SQL) to query one or more databases. After executing queries, the event creation module 606 creates events and puts them in event queues.

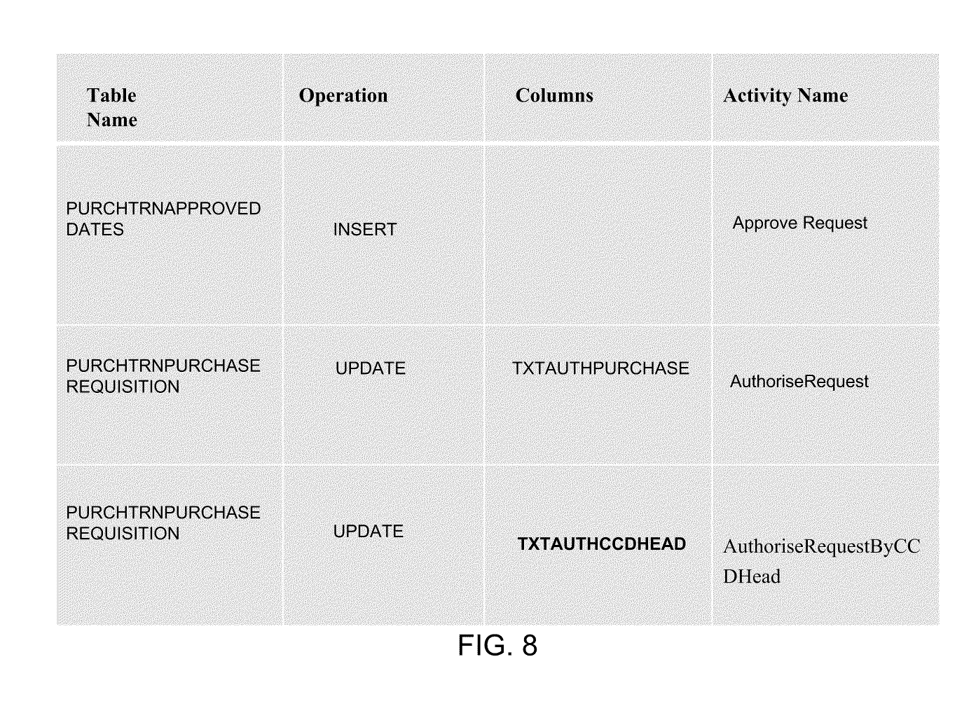

After the creation of events, the event handler 608 associates events to a relevant business activity. In an embodiment of the present invention, rule sets created by the configuration module 610 are used by the event handler 608 to create business activities from events. The configuration module 610 provides an interface to a user to define mapping between data events and business activities. The user describes mapping rules in order to connect data events with business activities and may also change mapping rules as and when required. For describing mapping rules, the user may use a rules template. In an embodiment of the present invention, a rules template includes a template table containing columns for defining attributes for an event and then associating the event with a business activity. For example, a database event in a template table is defined by attributes like table name, operation and the affected columns. Further, an activity associated with the event may be defined in another column. A sample format of a rule template table is illustrated in FIG. 8. The event handler 608 then processes the events generated by the event creation module 606 and creates multiple activity instances. The multiple activity instances are represented in the figure by the activity cloud 612. The activity cloud is then processed by the process sequence generator 614 to create process sequences for each process instance. Business activities having same transaction identifier are stitched into activity sequence and sorted based on the time of each activity. In case an activity is not correlated to any sequence, then a new activity sequence may be created. The activity sequences are then stored in process sequence storage 616 for further processing based on requirements of different process mining algorithms. The process mining module 620 is configured to implement one or more process mining algorithms for generating process models.

FIG. 7 illustrates sample format of a query information used for querying databases. As shown in the figure, the query information comprises six columns. In an embodiment of the present invention, the columns are: Table Name, Column Names, Operation, Query Conditions, Column Conditions and Column List. The description of the columns include:
1) Table Name: The table name of the identified and selected transaction table is recorded in this column.
2) Column Names: This column contains column names of the table. The columns of the table constitute event data. The minimum requirement is the transaction identifier and timestamp of event. Transaction identifier is the unique number generated for each process instance by the application under consideration.
3) Operation: It contains the value “UPDATE” if the column is updated or it contains the value “INSERT” if new row is inserted in the table.
4) Query Conditions: This condition defines condition to read data to identify events by setting the observance period. Observance period is the period during which data captured is sufficient to represent the entire business process behavior.
5) Column Conditions: Events are identified and mapped to activities based on their attributes. Based on the data in some columns of a table, the data set for events has to be captured. This column contains information on conditions on which update event on same column of a table is distinguished from other based on the data value.
6) Column List: The column names which are affected by “UPDATE” operation are recorded in this column.

FIG. 8 illustrates sample format of a rule template table. As shown in the figure, the rule template table comprises the following information:
1) Table Name: Name of the table for which rule is written.
2) Operation: The operation on column i.e. “UPDATE” if the columns are updated or “INSERT” new data row is added in the database table.
3) Columns: List of updated columns in case the operation is “UPDATE” or column data along with column name for corresponding business activity or the column condition on basis of which the rule is applicable.
4) Activity Name: Name of activity to which particular event occurred belongs to.

The present invention may be implemented in numerous ways including as a system, a method, or a computer readable medium such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A method for extracting process instance sequences from application data, the method comprising:
identifying and extracting data events from the application data persisting in system datastore, wherein the application data is data related to one or more software applications;
mapping each event to a business activity;
correlating activities to create process instance sequences; and
sorting activities based on timestamp information.

2. The method of claim 1 further comprising converting sequence data into format required by process mining algorithms.

3. The method of claim 1 further comprising using process sequence data for compliance checking.

4. The method of claim 1 further comprising using process sequence data for determining how process sequence is executed.

5. The method of claim 1, wherein the one or more software applications are independent of a particular software platform.

6. The method of claim 1 further comprising inputting formatted data into a process mining algorithm for generating a process model.

7. The method of claim 1, wherein the process related events are actions on application data such as update operations and write operations.

8. The method of claim 7, wherein the process related events are identified from target points within application data, further wherein the target points are mapped to end or start of an activity of a business process.

9. The method of claim 7, wherein the target points are at least one of database tables, logs, data files, new file creation in a folder and audit tables.

10. The method of claim 7 further comprising, prior to mapping each event to a business activity, creating a unique identifier for each business activity.

11. The method of claim 7, wherein the unique identifier is a correlation identifier used for correlating one or more business activities belonging to a common process instance.

12. The method of claim 9, wherein the step of mapping each event to a business activity comprises creating event definitions for associating an event to a business activity.

13. The method of claim 9, wherein the step of correlating activities comprises matching the correlation identifier among activities belonging to a common process instance in order to create process instance sequences.

14. A system for extracting process instance sequences from application data, the system comprising:
an event creation module configured to create data events from data changes logged by various business transactions;
an event handler configured to associate one or more events to a relevant business activities;
a configuration module configured to provide an interface to a user to define mapping between one or more data events and one or more business activities; and
a process sequence generator configured to create process sequences for each process.

15. The system of claim 14, wherein the configuration module is further configured to facilitate the creation of one or more rule-sets by a user, further wherein the one or more rule sets are used by the event handler to create business activities from data events.

16. The system of claim 14 further comprises:
a process sequence storage configured to store one or more process sequences created by the process sequence generator; and
a process mining module configured to implement one or more process mining algorithms for generating process models.
